(19) United States
(12) Patent Application Publication
(10) Pub. No.: US 2004/0062210 A1
(43) Pub. Date: Apr. 1, 2004

(54) System and method for providing conference calling over an IP network

(76) Inventors: Robert E. Genter, Arlington, MA (US); Darius Minai-Azary, Newton, MA (US); Malek Khouri, Saugus, MA (US); Leah Post, Allston, MA (US)

Correspondence Address: FLESHNER & KIM, LLP, P.O. Box 221200, Chantilly, VA, 20153-1200, US

(21) Appl. No.: 10/430,678

(22) Filed: May 7, 2003

Related U.S. Application Data
(63) Continuation-in-part of application No. 10/298,208, filed on Nov. 18, 2002.
(60) Provisional application No. 60/331,479, filed on Nov. 16, 2001.
(60) Provisional application No. 60/377,971, filed on May 7, 2002.

(51) Int. Cl. H04Q 11/00

(52) U.S. Cl. 370/260; 370/352

(57) ABSTRACT

A system and method for providing conference calling over an IP network includes establishing a conference calling platform capable of interacting with a gateway connected to the Internet. Conference call participants can directly access the conference calling platform via an analog telephone call carried over the PSTN. Conference call participants can also access the conference calling platform by placing a call that is routed over the Internet. In this instance the call would be removed from the Internet by the gateway, and then connected from the gateway to the conference calling platform. The gateway could send the call directly to the conference calling platform in a digital format, or the gateway could convert the call to an analog format, and then send the call to the conference calling platform via the PSTN. This allows participants to access a conference call via low cost International long distance calls that are carried over the Interent.

This application is a continuation-in-part of U.S. patent application Ser. No. 10/298,208 filed Nov. 18, 2002, which claims priority to U.S. Provisional Application Serial No. 60/331,479, filed Nov. 16, 2001, and U.S. application Ser. No. 10/094,671, filed Mar. 7, 2002. This application also claims priority to provisional application No. 60/377,971, filed May 7, 2002. Each of these applications is hereby incorporated by reference.

### BACKGROUND OF THE INVENTION

1. Field of the Invention

The invention relates generally to the field of communications, and more specifically to a system and method for providing conference calling over an IP network.

2. Background of the Related Art

Historically, most wired voice communications were carried over the Public Switched Telephone Network (PSTN), which relies on switches to establish a dedicated circuit between a source and a destination to carry an analog voice signal. More recently, Voice over Internet Protocol (VoIP) was developed as a means for enabling speech communication using digital, packet-based, Internet Protocol (IP) networks such as the Internet. A principle advantage of IP is its efficient bandwidth utilization. VoIP may also be advantageous where it is beneficial to carry related voice and data communications over the same channel, to bypass tolls associated with the PSTN, to interface communications originating with Plain Old Telephone Service (POTS) with applications on the Internet, or for other reasons. As discussed in this specification, the problems and solutions related to VoIP may also apply to Facsimile over Internet Protocol (FoIP).

FIG. 1 is a schematic diagram of a representative architecture in the related art for VoIP communications between originating telephone 100 and destination telephone 145. In alternative embodiments, there may be multiple instances of each feature or component shown in FIG. 1. For example, there may be multiple gateways 125 controlled by a single controller 120. There may also be multiple controllers 120 and multiple PSTN's 115. Hardware and software components for the features shown in FIG. 1 are well-known. For example, controllers 120 and 160 may be Cisco SC2200 nodes, and gateways 125 and 135 may be Cisco AS5300 voice gateways.

To initiate a VoIP session, a user lifts a handset from the hook of originating telephone 100. A dial tone is returned to the originating telephone 100 via Private Branch Exchange (PBX) 110. The user dials a telephone number, which causes the PSTN 115 to switch the call to the originating gateway 125, and additionally communicates a destination for the call to the originating gateway 125. The gateway will determine which destination gateway a call should be sent to using a look-up table resident within the gateway 125, or it may consult the controller 120 for this information.

The gateway then attempts to establish a call with the destination telephone 145 via the VoIP network 130, the destination gateway 135, signaling lines 155 and the PSTN 140. If the destination gateway 135 and PSTN 140 are capable of completing the call, the destination telephone 145 will ring. When a user at the destination telephone 145 lifts a handset and says “hello?” a first analog voice signal is transferred through the PSTN 140 to the destination gateway 135 via lines 155. The destination gateway 135 converts the first analog voice signal originating at the destination telephone 145 into packetized digital data (not shown) and appends a destination header to each data packet. The digital data packets may take different routes through the VoIP network 130 before arriving at the originating gateway 125. The originating gateway 125 assembles the packets in the correct order, converts the digital data to a second analog voice signal (which should be a “hello?” substantially similar to the first analog signal), and forwards the second analog voice signal to the originating telephone 100 via lines 155, PSTN 115 and PBX 110. A user at the originating telephone 100 can speak to a user at the destination telephone 145 in a similar manner. The call is terminated when the handset of either the originating telephone 100 or destination telephone 145 is placed on the hook of the respective telephone. In the operational example described above, the telephone 105 is not used.

In the related art, the controllers 120 and 160 may provide signaling control in the PSTN and a limited means of controlling a gateway at one end of the call. It will be appreciated by those skilled in the art that, in some configurations, all or part of the function of the controllers 120 and 160 as described above may be embedded into the gateways 125 and 135, respectively.

VoIP in the related art presents several problems for a provider of network-based voice communication services. For example, because packets of information follow different routes between source and destination terminals in an IP network, it is difficult for network service providers to track data and bill for network use. In addition, VoIP networks in the related art lack adequate control schemes for routing packets through PSTNs, gateways and VoIP networks based upon the selected carrier service provider, a desired Quality of Service (QoS), cost, and other factors. Moreover, related art controllers do not provide sufficient interfaces between the large variety of signaling systems used in international communications. Other disadvantages related to monitoring and control also exist with present VoIP schemes.

These and other problems ate solved by parent application U.S. patent application Ser. No. 10/298,208, filed Nov. 18, 2002 (Attorney Docket No. IB-0010), entitled System And Method For Voice Over Internet Protocol (VoIP) And Facsimile Over Internet Protocol (FoIP) Calling Over The Internet, which is hereby incorporated by reference and which is hereinafter referred to as the “Parent Application.” However, no prior art has utilized VoIP technology to provide faster and more cost effective conference calling.

### SUMMARY OF THE INVENTION

An object of the invention is to solve at least the above problems and/or disadvantages and to provide at least the advantages described hereinafter.

The invention provides a system and method of providing conference calling over an IP Network. The system and method according to the invention are faster and more cost effective than prior art conference calling systems and methods.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements, and wherein:

FIG. 1 is a schematic diagram of a system architecture providing VoIP communications, according to background art;

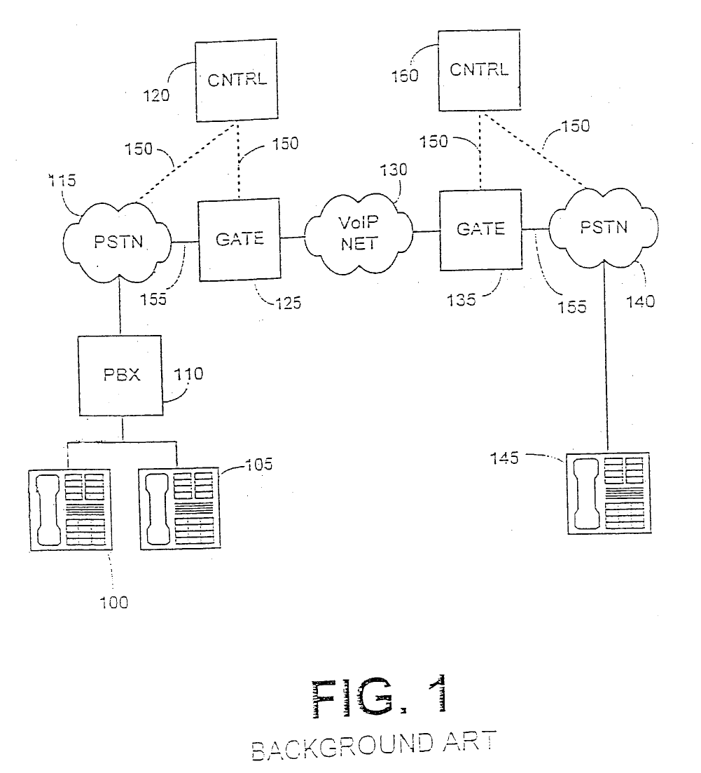

FIG. 2 is a schematic diagram of an exemplary system architecture providing VoIP/FoIP communications, employable in the system and method for providing conference calling over an IP network according to an embodiment of the invention;

FIG. 3 is a schematic diagram of an exemplary system architecture providing control for VoIP communications, employable in the system and method for providing conference calling over an IP network according to an embodiment of the invention;

FIG. 4 is a flow diagram of an exemplary method for routing control, employable in the system and method for providing conference calling over an IP network according to an embodiment of the invention;

FIG. 5 is a schematic diagram illustrating a system for providing conference calling over an IP network according to an embodiment of the invention;

FIG. 6 is a flow chart illustrating a method for providing conference calling over an IP network according to an embodiment of the invention; and

FIG. 7 is a flow chart illustrating another method for providing conference calling over an IP network according to an embodiment of the invention.

### DETAILED DESCRIPTION OF PREFERRED EMBODIMENTS

The system and method according to the invention may utilize a system and method for Voice over Internet Protocol (VoIP) and Facsimile over Internet Protocol (FoIP) calling over the Internet, such as that disclosed in the Parent Application to provide conference calling which is faster and more cost effective than prior art methods. A customer or user of the system and method is provided with a platform, which may be, for example, a prepaid platform, an interactive voice response (IVR) system or a conference bridge (discussed further below), which links conference call participants (hereinafter referred to as “participants”). One participant could be located in a first market area, while other participants are located in a second market area in a different country. Participants could be provided with a local access number or a toll free number, by which the participants may access the platform. The conference calling platform may also be capable of dialing out to bring additional participants into a conference call.

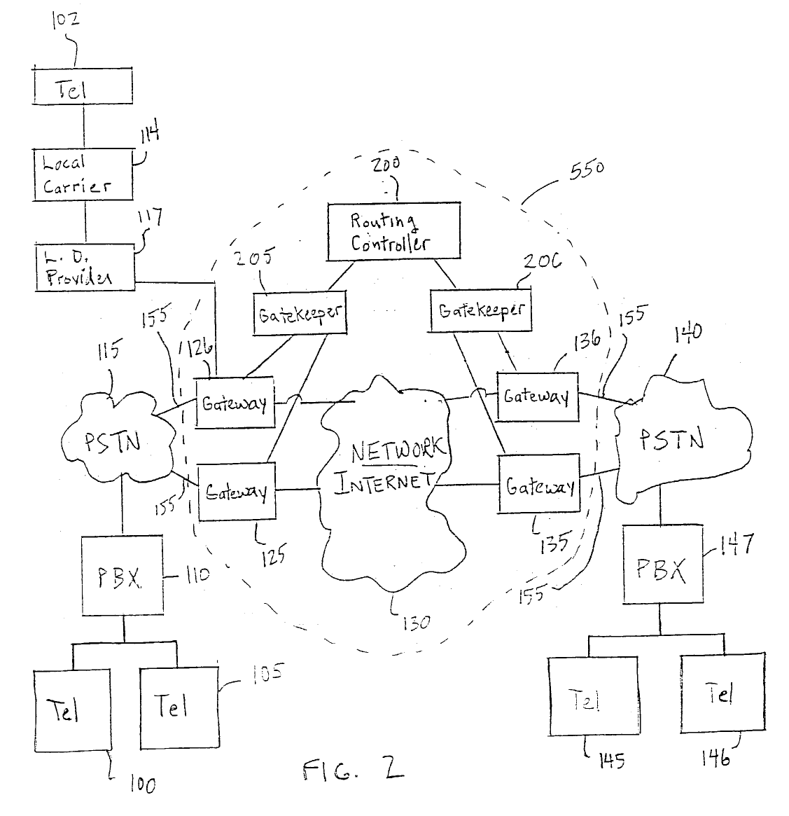

First, a system, such as that disclosed in the Parent Application, will now be described with reference to FIG. 2. This system can be used to implement the system and method for providing conference calling over an IP network according to embodiments of the invention.

The system depicted in FIG. 2 includes telephones 100/105 connected to a private branch exchange (PBX) 110. The PBX 110, in turn, is connected to a PSTN 115. Additionally, telephones 145/146 are connected to PBX 145, which, in turn, is connected to a PSTN 140. In addition, telephone 102 may be coupled to a local carrier 114, which in turn routes long distance calls to one or more long distance service providers 117. Those skilled in the art will recognize that calls could also originate from cellular telephones, or computer based telephones, and that those calls could also be routed through various carriers and service providers. Regardless of where the calls originate from, they are ultimately forwarded to an originating gateway 125/126 via the PSTN 115.

The originating gateways 125/126 function to convert an analog call into digital packets, which are then sent via the Internet 130 to a destination gateway 135/136. In some instances, the gateways may receive a call that has already been converted into a digital data packet format. In this case the gateways will function to communicate the received data packets to the proper destination gateways. However, the gateways may modify the received data packets to include certain routing and other formatting information before sending the packets on to the destination gateways.

The gateways 125/126/135/136 are coupled to one or more gatekeepers 205/206. The gatekeepers 205/206 are coupled to a routing controller 200. Routing information used to inform the gateways about where packets should be sent originates at the routing controller.

One of ordinary skill in the art will appreciate that although a single routing controller 200 is depicted in FIG. 2, a system such as that shown in FIG. 2 could include multiple routing controllers 200. In addition, one routing controller may be actively used by gatekeepers and gateways to provide routing information, while another redundant routing controller may be kept active, but unused, so that the redundant routing controller can step in should the primary routing controller experience a failure. As will also be appreciated by those skilled in the art, it may be advantageous for the primary and redundant routing controllers to be located at different physical locations so that local conditions affecting the primary controller are not likely to also result in failure of the redundant routing controller.

As depicted in FIG. 2, the digital computer network 130 used to communicate digital data packets between gateways may be compliant with the H.323 recommendation from the International Telecommunications Union (ITU). Use of H.323 may be advantageous for reasons of interoperability between sending and receiving points, because compliance with H.323 is not necessarily tied to any particular network, platform, or application, because H.323 allows for management of bandwidth, and for other reasons. Thus, in preferred embodiments, one function of the originating gateways 125 and 126 and the terminating gateways 135 and 136 may be to provide a translation of data between the PSTN=s 115/135 and the H.323-based VoIP network 130. Moreover, because H.323 is a framework document, H.225 protocol may be used for communication and signaling between the gateways 125/126 and 135/136, RTP protocol may be used for audio data between the gateways 125/126 and 135/136, and RAS (Registration, Admission, and Status) protocol may be used in communications with the gatekeepers 205/206.

The gatekeeper 205 may perform admission control, address translation, call signaling, call management, or other functions to enable the communication of voice and facsimile traffic over the PSTN networks 115/140 and the VoIP network 130. The ability to provide signaling for networks using Signaling System No. 7 (SS7) and other signaling types may be advantageous over network schemes that rely on gateways with significantly less capability. For example, related art gateways not linked to the gatekeepers of the present invention may only provide signaling for Multi-Frequency (MF), Integrated Services Digital Network (ISDN), or Dual Tone Multi-Frequency (DTMF).

The gatekeeper 205 may further provide an interface between different gateways, and the routing controller 200. The gatekeeper 205 may transmit routing requests to the routing controller 200, receive an optimized route from the routing controller 200, and execute the route accordingly.

Persons skilled in the art of communications will recognize that gatekeepers may also communicate with other gatekeepers to manage calls outside of the originating gatekeeper's zone. Additionally, it may be advantageous to have multiple gatekeepers linking a particular gateway with a particular routing controller so that the gatekeepers may be used as alternates, allowing calls to continue to be placed to all available gateways in the event of failure of a single gatekeeper. Moreover, although the gatekeeping function may be logically separated from the gateway function, embodiments where the gatekeeping and gateway functions are combined onto a common physical host are also within the scope of the invention.

As shown in FIG. 2, the routing controller 200 is logically coupled to gateways 125/126 and 135/136 through gatekeepers 205/206. The routing controller 200 contains features not included in the prior art signaling controllers 120 and 160 of the prior art systems described above in the background section of the present application, as will be described below. Routing controller 200 and gatekeepers 205/206 may be hosted on one or more network-based servers which may be or include, for instance, a workstation running the Microsoft Windows™ NTIM, Windows™ 2000, Unix, Linux, Xenix, IBM AIXIM, Hewlett-Packard UX™, Novell Netware™, Sun Microsystems Solaris™, OS/2™, BeOS™, Mach, Apache, OpenStep™ or other operating system or platform. Detailed descriptions of the functional portions of a typical routing controller embodying the invention is provided below.

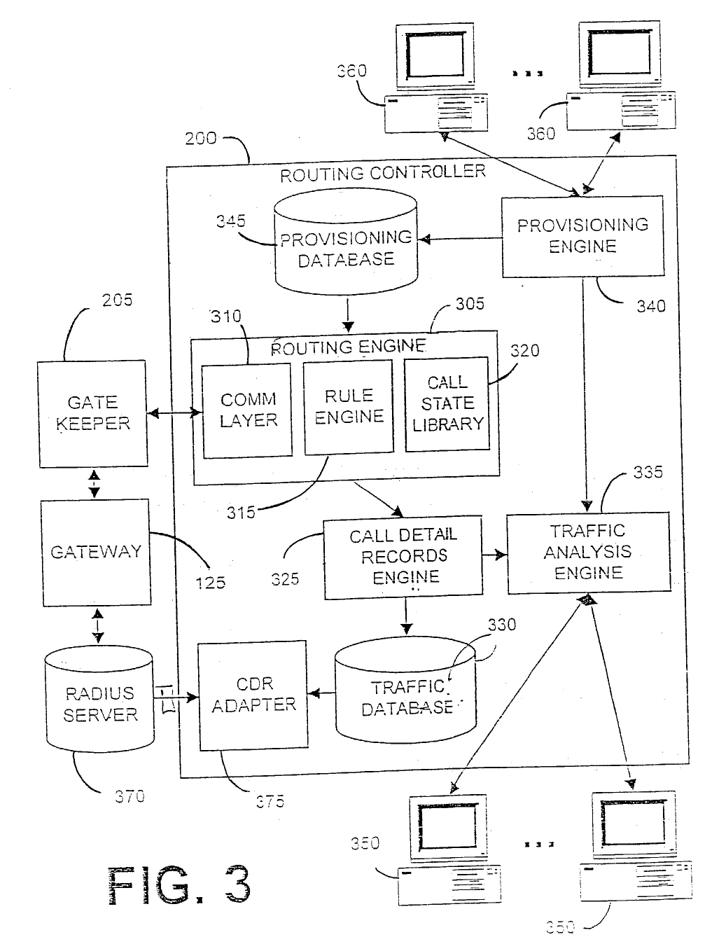

As indicated in FIG. 3, the routing controller 200 may include a routing engine 305, a Call Detail Record (CDR) engine 325, a traffic database 330, a traffic analysis engine 335, a provisioning engine 340, and a provisioning database 345. The routing engine 305, CDR engine 325, traffic analysis engine 325, and provisioning engine 340 may exist as independent processes and may communicate to each other through standard interprocess communication mechanisms.

In alternative embodiments, the routing engine 305, Call Detail Record (CDR) engine 325, traffic database 330, traffic analysis engine 325, provisioning engine 340, or provisioning database 345 may be duplicated to provide redundancy. For instance, two CDR engines 325 may function in a master-slave relationship to manage the generation of billing data.

The routing engine 305 may include a communications layer 310 to facilitate an interface between the routing engine 305 and the gatekeepers 205/206. Upon receipt of a routing request from a gatekeeper, the routing engine 305 may determine the best routes for VoIP traffic based upon one or more predetermined attributes such as the selected carrier service provider, time of day, a desired Quality of Service (QoS), cost, or other factors. The routing information generated by the routing engine 305 could include a destination gateway address, and/or a preferred Internet Service Provider to use to place the call traffic into the Internet. Moreover, in determining the best route, the rule engine 315 may apply one or more exclusionary rules to candidate routes, based upon known bad routes, provisioning data from provisioning database 345, or other data.

The routing engine 305 may receive more than one request to route a single call, for example, when a first routing attempt is declined by the terminating gateway, or otherwise fails to result in a connection, or where a previous routing attempt resulted in a disconnect other than a hang-up by the originator or recipient. To provide redundancy, the routing engine 305 may generate alternative routes to a particular far-end destination. For example, when the routing engine receives a routing request, the routing engine will return both preferred routing information, and alternative routing information. In this instance, information for at least one next-best route will be immediately available in the event of failure in the preferred route. Alternatively, routing engine 305 may determine a next-best route only after the preferred route has failed. An advantage of the latter approach is that routing engine 305 may be able to better determine the next-best route with the benefit of information concerning the most recent failure of the preferred route.

To facilitate alternative routing, and for other reasons, the routing engine 305 may maintain the state of each VoIP call in a call state library 320. For example, routing engine 305 may store the state of a call as “set up,” “connected,” “disconnected,” or some other state.

Routing engine 305 may further format information about a VoIP call such as the originator, recipient, date, time, duration, incoming trunk group, outgoing trunk group, call states, or other information, into a Call Detail Record (CDR). Including the incoming and outgoing trunk group information in a CDR may be advantageous for billing purposes over merely including IP addresses, since IP addresses may change or be hidden, making it difficult to identify owners of far-end network resources. Routing engine 305 may store CDR's in a call state library 320, and may send CDR's to the CDR engine 325 in real time, at the termination of a call, or at other times.

The CDR engine 325 may store CDR's to a traffic database 330. To facilitate storage, the CDR engine 325 may format CDR's as flat files, although other formats may also be used. The CDR's stored in the traffic database 330 may be used to generate bills for network services. The CDR engine 325 may also send CDR's to the traffic analysis engine 335.

Data necessary for the billing of network services may also be stored in a Remote Authentication Dial-In User Service (RADIUS) server 370. The RADIUS server 370 may also directly communicate with a gateway 125 to receive and store data such as incoming trunk group, call duration, and IP addresses of near-end and far-end destinations. The CDR adapter 375 may read data from both the traffic database 330 and the RADIUS server 370 to create a final CDR. The merged data supports customer billing, advantageously including information which may not be available from RADIUS server 370 alone.

The traffic analysis engine 335 may collect CDR's, and may automatically perform traffic analysis in real time, near real time, or after a predetermined delay. In addition, traffic analysis engine 335 may be used to perform post-traffic analysis upon user inquiry. Automatic or user-prompted analysis may be performed with reference to a predetermined time period, a specified outgoing trunk group, calls that exceed a specified duration, or according to any other variable(s) included in the CDR's.

The provisioning engine 340 may perform tasks necessary to route particular calls over the Internet. For example, the provisioning engine 340 may establish or modify client account information, authorize a long distance call, verify credit, assign phone numbers where the destination resides on a PSTN network, identify available carrier trunk groups, generate routing tables, or perform other tasks. For example, provisioning may be performed automatically, or provisioning may be performed with user input. Hybrid provisioning, that is, a combination of automated and manual provisioning, may also be performed. The provisioning engine 340 may further cause provisioning data to be stored in a provisioning database 345.

Client workstations 350 and 360 may be coupled to routing controller 200 to provide a user interface. As depicted in FIG. 3, the client(s) 350 may interface to the traffic analysis engine 335 to allow a user to monitor network traffic. The client(s) 360 may interface to the provisioning engine 340 to allow a user to view or edit provisioning parameters. Alternatively, a client may be adapted to interface to both the traffic analysis engine 335 and provisioning engine 340, or to interface with other features of routing controller 200.

In a system embodying the invention, as shown in FIG. 2, the gateways 125/126 would first receive a request to set up a telephone call from the PSTN, or from a Long Distance Provider 117, or from some other source. The request for setting up the telephone call would typically include the destination telephone number. In order to determine which destination gateway should receive the packets, the gateway would consult the gatekeeper.

The gatekeeper 205, in turn, may consult the routing controller 200 to determine the most appropriate destination gateway. In some situations, the gatekeeper may already have the relevant routing information. In any event, the gatekeeper would forward the routing information to the originating gateway 125/126, and the originating gateway would then send the appropriate packets to the appropriate destination gateway. As mentioned previously, the routing information provided by the gatekeeper may include just a preferred destination gateway, or it may include both the preferred destination gateway information, and information on one or more next-best destination gateways.

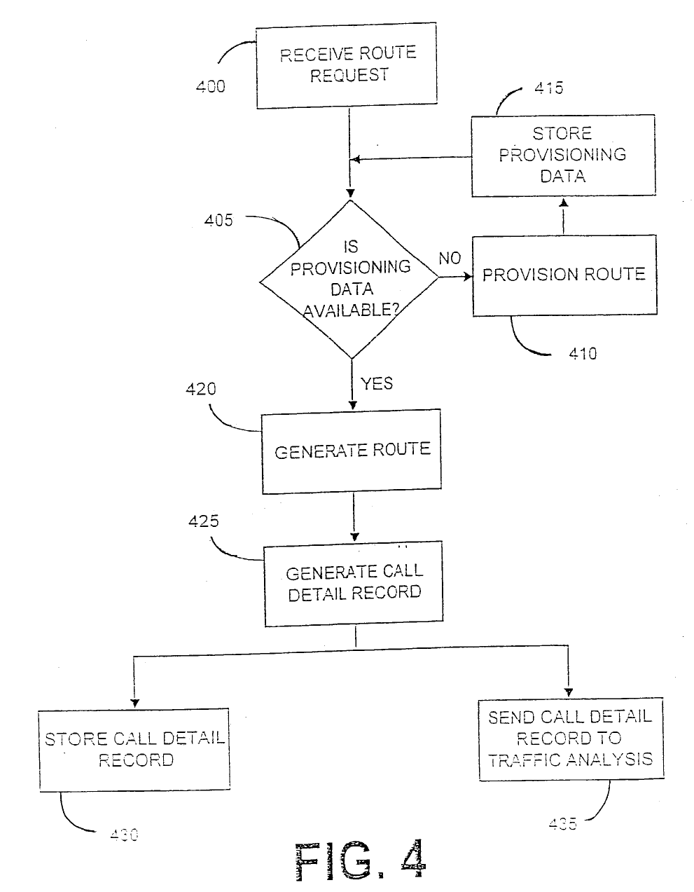

FIG. 4 is a flow chart illustrating a method for using the routing controller 200, which may be utilized in the invention. In step 400, the routing controller 200 receives a routing request from either a gatekeeper, or a gateway. In step 405, a decision is made as to whether provisioning data is available to route the call. If the provisioning data is not available, the process advances to step 410 to provision the route, then to step 415 for storing the provisioning data before returning to decision step 405.

If, on the other hand, if it is determined in step 405 that provisioning data is available, then the process continues to step 420 for generating a route. Step 420 may result in the generation of information for both a preferred route, and one or more alternative routes. The alternative routes may further be ranked from best to worst.

The routing information for a call could be simply information identifying the destination gateway to which a call should be routed. In other instances, the routing information could include information to identify the best Internet Service Provider to use to place the call traffic onto the Internet. In addition, the routing controller may know that attempting to send data packets directly from the originating gateway to the destination gateway is likely to result in a failed call, or poor call quality due to existing conditions on the Internet. In these instances, the routing information may include information that allows the data packets to first be routed from the originating gateway to one or more interim gateways, and then from the interim gateways to the ultimate destination gateway.

Step 420 may also include updating the call state library, for example with a call state of “set up” once the route has been generated. Next, a CDR may be generated in step 425. Once a CDR is available, the CDR may be stored in step 430 and sent to the traffic analysis engine in step 435. Steps 430 and 435 may be performed in parallel, as shown in FIG. 4. Alternatively, steps 430 and 435 may be performed sequentially, or only step 430 or only 435 may be performed.

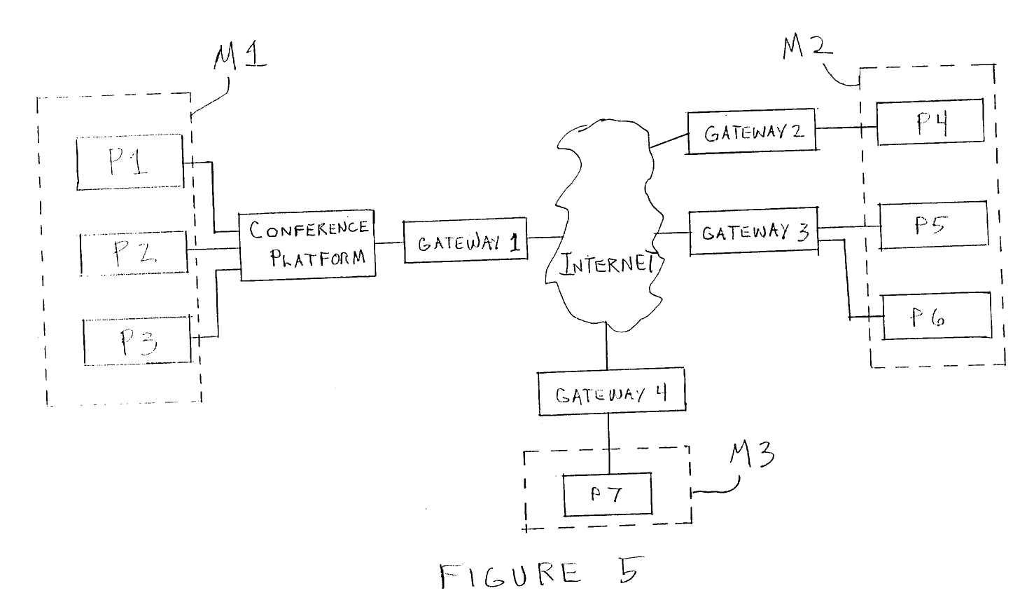

A system for providing conference calling over an IP network mau utilize the system and method for Voice over Internet Protocol (VoIP) and Facsimile over Internet Protocol (FOIP) discussed above. For example, a system for providing conference calling over an IP network according to an embodiment of the invention is shown in FIG. 5. FIG. 5 shows conference call participants P1, P2 and P3 in a first market area M1, conference call participants P4, P5 and P6 in a second market area M2, and conference call participant P7 in a third market area M3. Each market area could be a different area code within a single country, or completely different countries. The greatest cost savings of a system and method embodying the invention would come when the participants are located in different countries, and participants can access the conference call via a low cost telephone call that is routed over the Internet.

A conference call platform could be located virtually anywhere, and the conference call platform would be linked to the Internet through a gateway. The conference call platform would be capable of accessing a Voice over Internet system like the one described above, either directly, or via regular analog PSTN lines.

In the embodiment shown in FIG. 5, the conference call participants P1, P2 and P3 directly access the conference call platform via normal analog telephone lines over the PSTN. The conference call platform is then linked to Gateway 1 via direct digital lines, or via an analog telephone line in the PSTN. Participant P4 would access the conference call platform by routing a call through Gateway 2, the Internet and Gateway 1. Participants P5 and P6 access the conference call platform via Gateway 3, the Internet, and then Gateway 1. Participant P7 accesses the conference call platform via Gateway 4, the Internet, and Gateway 1.

The system depicted in FIG. 5, which utilizes a voice over Internet system as described above, allows the participants in market areas 2 and 3 to simply dial a local access number or a toll free number to access a gateway in their area. Once the call reaches the gateway in their area, the call is converted into digital data packets, as described above, and the call is routed through the Internet to a gateway in the same market area as the conference call platform. The call is then either routed directly to the conference call platform, or the call is converted into an analog form and is routed over an analog line in the PSTN to the conference call platform. This allows participants in all market areas to join a conference call by dialing a local or toll free number, which greatly reduces the cost compared to existing International conference calling services.

Although the embodiment shown in FIG. 5 allows participants P1-P3 to directly call the platform, in other embodiments the conference call platform may not be directly accessible to any participants. In this instance, all participants would access the conference call platform via the voice over Internet system, which routes call through the Internet.

The conference call platform could be commercially configured in many different ways. For instance, the conference call platform could be configured as a prepaid platform. In other embodiments, the conference call platform could be configured to charge a user who originally set up the conference call a conference calling fee which would cover the cost configuring and operating the conference calling platform. The participants might then be charged additional amounts for joining the conference call. In this embodiment, different participants might be charged different amounts depending on where they are calling from. Even in this embodiment, participants would still be paying much lower rates than for traditional International conference calling because the calls can be routed over the Internet less expensively than they could be carried over traditional PSTN-based International calling links. One skilled in the art will appreciate that any number of other schemes could also be used to charge participants for the conference calling service.

The conference calling platform could also include an interactive voice response (IVR) system that is used to route participant callers into the appropriate conference call. The platform could also operate like a typical conference calling bridge. In addition, the conference calling platform might allow an operator, a user or a participant to initiate an outbound call from the conference calling platform to call additional participants. In this instance, a participant that is called by the conference calling platform might not be charged at all for joining the conference call.

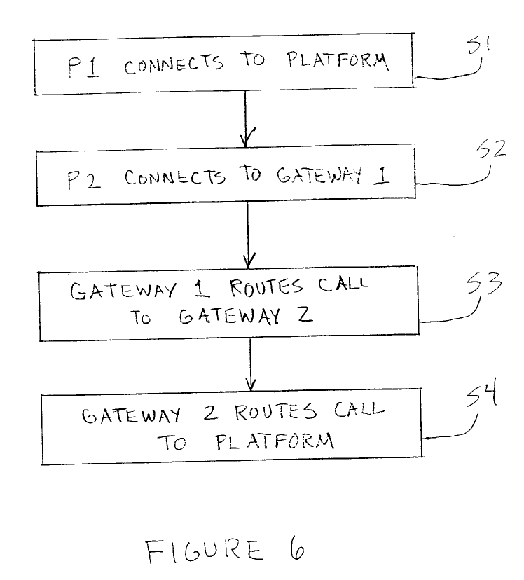

FIG. 6 is a flowchart illustrating a method according to an embodiment of the invention. In step S1, a first participant in a first market area calls a local or toll-free number to access the conference calling platform. In this embodiment, the first participant would access the conference calling platform directly through an analog telephone line via the PSTN.

In step S2, a second participant in a second market area would call a telephone number to access the conference calling platform. In some embodiments, the second participant may be dialing a local or toll-free number that connects his telephone with a gateway within the second market area. In other embodiments, the second participant may be dialing a number corresponding the conference calling platform in the first market area. In any event, the second participant would connect to a first gateway within his market area. Depending on how the conference calling platform is configured, the second participant may be charged nothing for the call, he may be charged for only a local telephone call, he may be charged the long distance rate for calls carried over the Internet, or he may be charged a special rate for the conference call.

In step S3, the gateway connected to the second participant's phone would convert the call into a digital data format and would route the call over the Internet to a second gateway capable of accessing the conference calling platform, either directly, or through an analog telephone line over the PSTN.

In step S4, the second gateway would route the call from the second participant to the conference calling platform. If the second gateway is directly connected to the conference calling platform, the call may be delivered to the conference calling platform in either a digital or an analog format, depending on the capabilities of the conference calling platform. In other embodiments, where the second gateway is connected to the conference calling platform via an analog telephone line, step S4 would comprise converting the digital data packets received from the first gateway back into an analog format, and then routing the call through an analog telephone line to the conference calling platform.

At this point, the conference calling platform would connect the first participant with the second participant through the conference calling platform. Additional participants would then join the conference call by either calling the conference calling platform directly, or by accessing the conference calling platform through gateways.

In some methods embodying the invention, all participants may access the conference calling platform via gateways connected to the Internet.

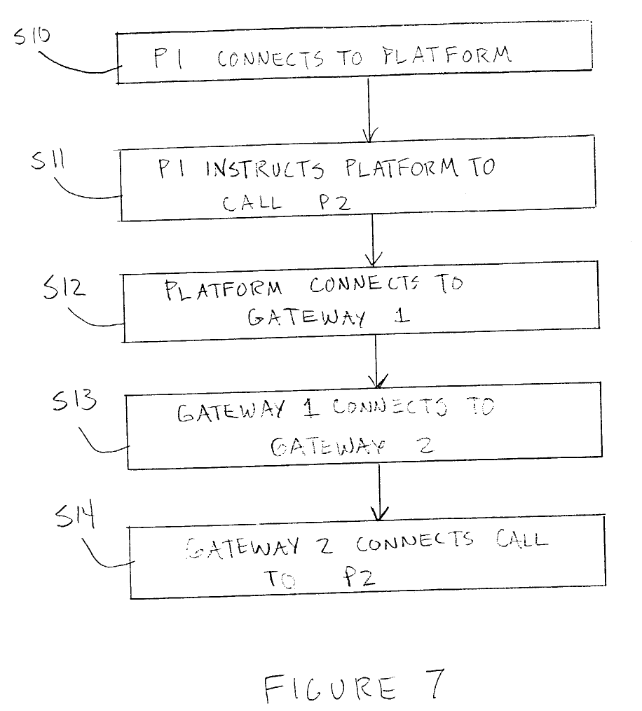

FIG. 7 illustrates another method embodying the intention. In this method, in step S10, a first participant connects to the conference calling platform. The first participant may call the conference calling platform directly over an analog telephone line of the PSTN, or the first participant may connect to the conference calling platform through the Internet via a gateway coupled to the conference calling platform and a gateway coupled to the first participant's telephone.

In step S11, the first participant would instruct the conference calling platform to place a telephone call to a second participant so that the second participant could join the conference call. This could be done using a live operator, using an Interactive Voice Response system that is a part of the conference calling platform, or even by a computer interface to the conference calling platform that is totally separate from the call established between the first participants telephone and the conference calling platform.

In step S12, the platform would connect to a first gateway coupled to the Internet, and the conference calling platform would instruct the first gateway to place a call to the second participant's telephone. As explained above for the voice over Internet system, the first gateway would determine which gateway to send the call to, and the first gateway would connect to a second gateway that is capable of completing the call to the second participant.

In step S14, the second gateway would then complete the call to the second participant. As a result, the second participant would be on the conference call with the first participant, with the conference call being hosted by the conference calling platform, and the call to the second participant being carried over the Internet.

As this point the method could continue as additional calls are placed to more participants. In addition, other participants could call to the conference calling platform, either directly, or through the Internet, to join the conference call first established between the first and second participants.

In the systems and methods described above, multi-national conference calls may be established linking participants in the same or difference market areas. Because the participants can use local or toll free access numbers, they need not incur substantial long distance fees. Further, because the calls are routed over the Internet, using a network system such as the system disclosed in the Parent Application, the calls are higher quality and faster with respect to prior art conference calling methods.

The foregoing embodiments and advantages are merely exemplary and are not to be construed as limiting the invention. The present teaching can be readily applied to other types of apparatuses. The description of the invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for providing conference calling over an IP network, the method comprising:
establishing a conference calling platform that can be accessed by participants via a gateway connected to the Internet;
connecting a first participant to the conference calling platform; and
connecting at least one additional participant to the conference calling platform through a telephone call that is carried over the Internet, and that accesses the conference calling platform via the gateway.

2. The method of claim 1, wherein the gateway accessible to the conference calling platform is a first gateway, and wherein the step of connecting the at least one additional participant comprises:
connecting the at least one additional participant's telephone to a second gateway by a telephone call placed from the at least one additional participant's telephone;
converting the at least one additional participant's telephone call into digital data packets with the second gateway;
sending the digital data packets from the second gateway to the first gateway via the Internet; and
connecting the at least one additional participant's call from the first gateway to the conference calling platform.

3. The method of claim 2, wherein the step of connecting the at least one additional participant's call from the first gateway to the conference calling platform comprises directly connecting the first gateway to the conference calling platform so that digital data can be sent between the first gateway and the conference calling platform.

4. The method of claim 2, wherein the step of connecting the at least one additional participant's call from the first gateway to the conference calling platform comprises:
converting the digital data packets received by the first gateway into an analog telephone call format; and
sending the analog telephone call to the conference calling platform via an analog telephone line.

5. The method of claim 1, wherein the gateway accessible to the conference calling platform is a first gateway, and wherein the step of connecting the at least one additional participant comprises:
connecting the conference calling platform to the first gateway;
placing a telephone call from the conference calling platform to the at least one additional participant's telephone, wherein the call is sent from the first gateway, over the Internet, to a second gateway that is capable of completing the call to the at least one additional participant's telephone; and
completing the call from the second gateway to the at least one additional participant's telephone.

6. The method of claim 1, wherein the step of connecting a first participant to the conference calling platform comprises the first participant calling a local or toll-free number to directly connect to the conference calling platform.

7. The method of claim 1, wherein the step of connecting a first participant to the conference calling platform comprises the first participant calling the conference calling platform via the Internet, wherein the call from the first participant is delivered to the conference calling platform via the gateway.

8. The method of claim 1, wherein the step of establishing a conference calling platform comprises establishing a conference calling platform that interacts with participants via an interactive voice response (IVR) system.

9. The method of claim 1, wherein the step of establishing a conference calling platform comprises establishing a conference calling platform that acts as a conference bridge to connect participants.

10. A system for providing conference calling over an IP network, comprising:
a gateway connected to the Internet that is capable of receiving telephone calls in a digital data packet format from the Internet; and
a conference calling platform configured to receive a telephone call from the gateway such that a conference call can be established with a participant through the gateway.

11. The system of claim 10, wherein the conference calling platform is configured to be directly coupled to the gateway such that a telephone call from the gateway can be connected to the conference calling platform via a digital data interface between the gateway and the conference calling platform.

12. The system of claim 10, wherein the conference calling platform is also configured to-receive analog format telephone calls from the PSTN.

13. The system of claim 12, wherein the gateway is configured to convert a telephone call received from the Internet from a digital data format into an analog format, and wherein the gateway is also configured to forward the analog format telephone call to the conference calling platform over the PSTN.

14. The system of claim 10, wherein the conference calling platform is configured to interact with participants via an interactive voice response (IVR) system.

15. The system of claim 10, wherein the conference calling platform comprises a conference bridge that connects participants in a conference call.

16. The system of claim 10, wherein the conference calling platform is configured to place a telephone call to a participant to add the participant to a conference call.

17. The system of claim 16, wherein the conference calling platform is configured to place a telephone call to a participant via the gateway, and the Internet.

18. A method of conducting a conference call over an IP network, comprising:
dialing an access number with a first user's telephone to access a conference calling platform; and
dialing an access number with a second user's telephone to access the conference calling platform via an IP network, such that the first user can talk to the second user via their respective telephones.

19. The method of claim 18, wherein the step of dialing an access number with a first user's telephone comprises dialing a local or toll-free telephone number.

20. The method of claim 18, further comprising outdialing from the conference calling platform to a third user's telephone to join a third user to the conference call.
